(19) United States
(12) Patent Application Publication
(10) Pub. No.: US 2018/0268407 A1
(43) Pub. Date: Sep. 20, 2018

(54) APPARATUS AND METHOD FOR PAYMENT AUTHORIZATION AND AUTHENTICATION BASED TOKENIZATION

(71) Applicant: TokenID, Inc., Mineola, NY (US)

(72) Inventor: Leonid Voldman, Haifa (IL)

(21) Appl. No.: 15/923,816

(22) Filed: Mar. 16, 2018

Related U.S. Application Data
(60) Provisional application No. 62/473,406, filed on Mar. 19, 2017.

(51) Int. Cl. G06Q 20/40; G06Q 20/38

(52) U.S. Cl. CPC G06Q 20/409; G06Q 2220/00; G06Q 20/385; G06Q 20/3829

(57) ABSTRACT

A method and system for providing secure card-based discrete or repeating transactions. A client having a credit/debit card, e-wallet or other financial account generates unique tokenized payment credentials for the card transaction using a local computer process. The tokenized payment credentials comply with Payment Card System format and can be provided to the merchant and included in a transaction authorization message from the merchant. A payment authorization server within the card payment system authenticates the tokenized credentials and forwards a transaction authorization message to an issuer or other payment processor.

### CROSS-REFERENCE TO RELATED APPLICATIONS

This application claims priority to U.S. Provisional Application No. 62/473,406 filed on Mar. 19, 2017, the entire contents of which is expressly incorporated by reference.

### FIELD OF THE INVENTION

The invention relates generally to electronic payment security and, more particularly, to improvements in security of electronic financial transactions and payment tokenization, scalability and interoperability.

### BACKGROUND

Electronic transactions are commonly made using payment cards, such as credit, debit, prepaid and other types of payment cards. FIG. 1 illustrates a conventional credit or debit card payment authorization scheme. In order to perform a payment transaction, a customer provides their payment credentials, such as those stored or printed on payment card 101, to a merchant 102. The payment card 101 can be a credit card, a debit card, a pre-paid card, or other transaction card. For a card present (CP) or offline transaction, the payment credentials can be provided to the merchant 102 through a point of sale (POS) equipment 102a, such as a credit/debit card swipe or chip machine. For a for card-not-present (CNP) transaction, such as an on-line purchase where the customer is remote from the merchant, the customer enters payment credentials (e.g., the information that is required to complete payment transaction) and possibly other information into an on-line payment system 102b. Payment credentials are generally in the form of a data structure that contains information required to complete payment transaction, such as a card number, cardholder name, CVV, etc. The payment credentials may be different for different types of payment transactions.

Conventional payment transactions generally involve two stages: authorization (real-time) and settlement (off-line). Authorization begins with the merchant sending an authorization message to a Payment Processor 103. The authorization message can contain the payment credentials and other transaction details, such as a transaction amount, time of transaction, merchant ID, etc. In conventional systems, the payment credentials and other transaction information are sent in a Financial Transaction Message that complies with the Financial Transaction Card Originated Interchange messaging format defined by the ISO 8583 specification.

The Payment Processor 103 can be a clearing system, the merchant's own payment processor, an acquirer's payment processor, etc. The Payment Processor 103 passes the authorization message to the Acquirer 104 (generally a bank that provides the account, hardware and/or software needed for the merchant to accept card-based payments). The Acquirer 104 delivers the authorization message to the appropriate Credit Card Association Network 105 (such as VisaNet for Visa or BankNet for MasterCard). In some instances, the payment processor 103 may be connected directly to the Credit Card Association Network 105. The Credit Card Association Network 105 passes the authorization message to the appropriate Issuer 106 (the bank or other organization that issued the card to the user). At each stage, additional routing and other information may be added to or removed from the authorization message as it passes through the system. The Issuer 106 verifies that the payment credentials in a received authorization message are valid and then approves or denies the transaction for which authorization is being sought. The approval or rejection message is then routed back to the Acquirer 104 which then sends an approval/decline code to Merchant's POS device 102a or on-line system 102b. If the transaction is approved, it is subsequently completed using a standard clearance and settlement process in which the merchant is ultimately paid and the card holder billed for the transaction in the appropriate currencies.

FIG. 2 shows the various types of information that is printed on a conventional payment card and which is used in card-present or card-not-present transactions. This information is often embossed into and printed onto the payment card. The information, as well as additional data, can also be stored in computer readable media on the card (such as magnetic strip, microchip with wired or wireless interface, etc.) to support payment capabilities at a card-present POS terminal. While the information is shown here in the context of a ‘card’, a physical card is not required for a user to engage in card-not-present transactions. Rather, only the appropriate card information is needed.

The Primary Account Number (PAN) 112 identifies the account's issuer 106 and the particular cardholder account to which transactions are applied, such as the relevant charging account at the issuing bank. The PAN for conventional credit and debit cards is formatted in accordance with the ISO/IEC 7812 standard. The first six digits are the Issuer Identification Number (IIN)/Bank Identification Number (BIN) 115, which identifies the category of the card issuer (such as bank) and uniquely identifies the issuing organization, e.g., the particular Issuer 106. The next set of digits is the Individual Account Identification (IAI) 116, which has up to 12 digits and identifies the individual's account number. These are followed by a single check digit 117, conventionally calculated using the Luhn algorithm. The PAN is most commonly sixteen digits length and under the current standard can be up to 19 digits, varying primarily due to different length account numbers. The Cardholder Name field 111 is a character field (generally 2-26 characters) that specifies the cardholder name.

The Card Verification Value (CVV) 114 is a secure feature used for card-not-present transactions and is intended to reduce fraud. It is typically three or four digits. The CVV is sometimes referred to as Card Security Code (CSC), Card Verification Data (CVD), Card Verification Number (CVN or CVN2), Card Verification Value Code (CVVC), Card Verification Code (CVC or CVC2), Verification Code (V-code or “V code”), Card Code (CID), etc.

The Expiration Date 113 is a four digit value in the format YYMM and defines the card validity period. Finally, a three digit service code 118 is provides information used in authorization processing and specifies restrictions on where and how the card can be used (e.g., national or internationally, with or without a PIN, etc.).

The risk of card fraud in conventional payment systems is a significant concern. Payment credentials provided to a merchant or obtained by another third party can be misused to make fraudulent transactions. Because access to the payment credentials can permit unauthorized charges to the user's account, the Payment Card Industry (“PCI”) requires that steps be taken to protect the payment data (e.g. PAN) from potential cyber attackers and other forms of misuse.

Payment card data tokenization is one way to address the problem of card fraud. Tokenization is a method for protecting the payment data contained on a payment card by substituting an alternative sequence of numbers, called a “token”, for some or all card's details, including the Primary Account Number (PAN). The token is provided to the merchant instead the actual PAN. The token is strongly linked to the actual PAN so that the PAN can be recovered during downstream processing and the transaction can be approved and processed by the issuing bank.

In cloud tokenization, a card holder that wants to engage in an on-line transaction can request a one-time credit card number from their card issuer. A central server maintained by a third party receives the request from the user and issues a payment token to a user in the form of a special one-time-use credit card number. A potential intruder who tries to reuse a token that was already used for the one valid transaction will not be able to abuse it since the token will be no longer valid. As a result, even if the tokenized data is improperly accessed at a later date, it cannot not be used to issue transactions on the user's account. Tokenization thus provides security from attacks such as Man-In-The-Middle (MITM), Man-In-The-Browser (MITB), phishing, repository breaches and other attacks.

The one-time-use card number is typically pulled from a pool of available tokens and cannot be reused in a different transaction until settlement of the relevant transaction is complete. This process can take several days. As a result, when the system is scaled and the number of concurrent transactions increases, there can be a deficit of available one-time-use tokens. In addition, particularly for mobile tokenization, the transaction processing requires stable network connections from the user to the third party server that provides the tokens on demand. Further, conventional cloud tokenization systems are also designed for single transactions and do not allow for transparent recurring payments nor do they support payment refund.

Certain client-side card security processes are also known. However, these do not address securing the account information on the network from improper access and reuse. For example, the EMV standard provides a chip and PIN procedure to provide security for card-present transactions. A microchip in the card or other user device interacts with the point of sale (POS) terminal to validate the card number and certain data used in the transaction. While this provides a strong form of authentication of the physical card itself, the PAN itself is not kept confidential in the transaction. In addition, since EMV relies on the interaction between the card's chip and the POS device, it is only applicable in card-present transactions and does not apply to card-not-present transactions, such as e-commerce and other on-line transactions.

### SUMMARY

The present invention provides a highly secure payment tokenization system and method in which secure tokenized payment credential are generated on demand the client side on an as-needed basis and without requiring the card holder to have an internet or other network connection to engage in transactions. The method and system can be implemented in a manner transparent to the merchant's payment facilities and to established payment networks (e.g. BankNet, VisaNet, etc.) and supports a substantially unlimited number of simultaneous transactions. The method and system can be implemented with the awareness of a card issuer and/or payment service provider. Alternatively, implementation can be done independently of and transparent to issuers.

In one embodiment, a client initially registers with the system. Registration can be managed by a payment authorization server, issuer, or other system. In the registration process, the client provides their payment service account or other payment means to be used (such as a credit card number) and is assigned an account identifier that unambiguously identifies the payment account within the payment authorization server. One or more cryptographic keys are generated and exchanged. The client account identifier and relevant keys are stored in an account record at the client device. The client account identifier, relevant, keys, and (depending in implementation) the client payment account number are stored in an account record at the payment authorization server. Other payment and client data can also be stored by the payment authorization server as may be appropriate,

When the client wants to engage in a transaction with a merchant, a one-time password (OTP) is generated by the client using a cryptographic function that operates on seed data comprising one or more of the key(s) stored at the client and information unique to the transaction, such as the merchant ID and transaction amount. Additional data such as a global time, the expiration date of the user's linked card account, and information from other externals sources can be used as seed data as well. The generated OTP and the user's account identifier are substituted for other payment credential information on the card, preferably including at least the card account number. Other information indicating that the transaction is associated with the payment authorization server is also provided. The modified card information is formatted to comply with the applicable format requirements and the resulting tokenized card number, which presents a OTP value for the transaction, is provided to the merchant as payment credentials.

For example, for a conventional card format, the assigned user account number can replace the cardholder name field and the generated OTP can replace part or all of the card account number and, optionally the CVV fields, or vice versa. The payment authorization server can be assigned its own Issuer Identification Number and this value used in the IIN field. A valid checksum and other required data can also be generated so that dynamically generated tokenized payment credentials comply with the PCI card format expected by the merchant and downstream entities in the card payment network, i.e., the payment credentials format matches Payment Card Industry (PCI) requirements such as set forth in the ISO/IEC 7812 standard specification.

The merchant processes the transaction using the OTP tokenized card number as it would other card transactions by sending a transaction message to the card payment network for approval. Data in the payment credentials signal that the transaction message should be routed to the payment authorization server. For example, the value of the IIN field can signal the credit card association network to route the transaction message to the payment authorization server (which would appear to the credit card association as simply another issuer) directly or through Issuing bank/processor facilities. The payment authorization server can be associated with more than one payment network and have multiple BINs.

When the payment authorization server receives the transaction message, it accesses the user account indicated by the account identifier and uses one or more of the stored key(s), information about the transaction in the transaction message, and other data such as a global time, to generate a OTP using an algorithm corresponding to the one used by the client device.

If the generated OTP and the received OTP do not match, the payment authorization server can return a transaction declined message. If the generated OTP and the received OTP match, the transaction is authenticated. The payment authorization server then generates a message that is sent (directly or indirectly) to the entity that can approve or deny the transaction request based, e.g., on a user's available funds or credit limit.

In one embodiment, the payment authorization server operates transparently to the issuer. In this embodiment, when the payment authorization server authenticates a tokenized transaction message it generates a corresponding untokenized transaction message in which at least some of the cardholder information linked to the account identifier, such as the card account number, cardholder name, etc. is substituted back in to replace the tokenized data. The untokenized transaction message is then sent to the appropriate issuer, directly or indirectly, where it is treated it as a conventional transaction message that was not tokenized. For example, the untokenized transaction can be sent back to the credit card association network which will then route it to the correct issuer. The response (approving or rejecting the transaction) is then returned, processed and passed back through the card payment network to the merchant.

Alternatively, the payment authorization server can be integrated into or otherwise known to the issuer or to a separate payment service provider which is used for transaction approval. In this configuration, this message sent can be formatted in any suitable manner as long as it includes enough information for the transaction to be approved. Preferably, the message includes at least an account identifier (in one form or another) and transaction information, such as the amount of the transaction. The payment authorization server may be integrated with more than one system and the message format used, e.g., for an issuer or for a payment service provider, can be different.

Advantageously, the method and system allows a client to engage in a secure tokenized transaction without having to request a one-time-use credit card number from a remote server. Because the tokenized card data is generated on the client-side, the system does not suffer from token shortages when there are large volumes of overlapping transactions and does not require a network connection to the payment authorization server or other device. In some configurations, a registered payment client can be used for transactions without the need to access any remote system other than the merchant own. As a further advantage, the user can also engage in multiple tokenized transactions based on the same original card number simultaneously.

According to a further feature of an embodiment a payment client and payment authorization server are configured to support secure payment credentials for use in recurring payments. Tokenized payment credentials for recurring transactions can be reused by the merchant within defined limits on reuse. The credentials issued for specific merchant (and customer) are preferably not valid for other businesses (or other customers).

In one embodiment, the generated payment credentials for a recurring transaction includes a flag signaling that the payment is recurring. The payment credentials can also include data imposing date limits of the recurring payments. Other limits can be stored in the client account record at the payment authorization server. The OTP for a recurring transaction is generated without the use of time-dependent information, such as a global time, in the seed data, so that the payment authorization server can verify the OTP at times far from when the OTP was generated at the client. Different keys and/or a different OTP cryptographic function can also be used for recurring transactions.

The tokenized payment credentials for a recurring transaction can be stored by the merchant and transactions issued using them on a recurring basis. When a recurring transaction is received by the payment authorization server, the payment authorization server retrieves and applies the OTP seed data appropriate for that recurring transaction and uses the generated OTP to verify the OTP in the transaction message. The payment authorization server also can consider other information related to the transaction, such as information contained in the credentials or stored in the client account record, to determine if the transaction is within recurrence limits. Provided it is, the transaction is authenticated and the transaction request sent to the card issuer or payment service provider for approval.

### BRIEF DESCRIPTION OF THE DRAWINGS

Further features and advantages of the invention, as well as structure and operation of various implementations of the invention, are disclosed below with references to the accompanying drawings, in which:

FIG. 1 illustrates a conventional credit or debit card payment authorization scheme;

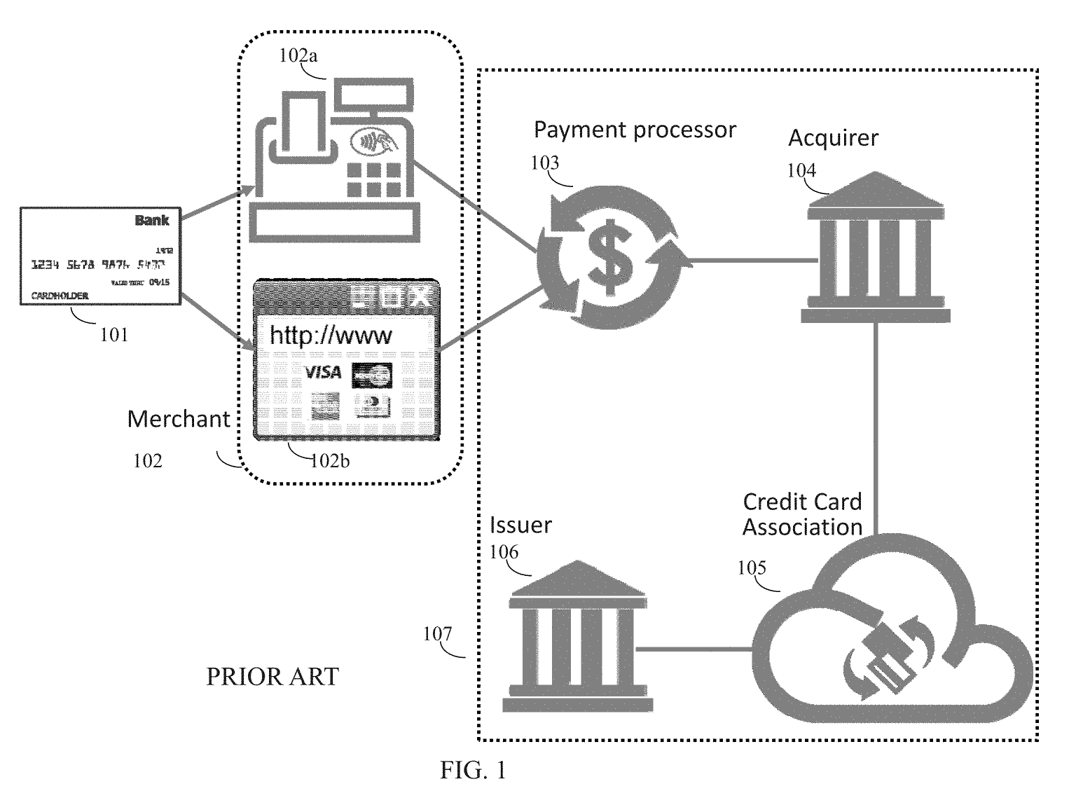

FIG. 2 shows the various types of information that is printed on a conventional payment card and which is used in card-present or card-not-present transactions;

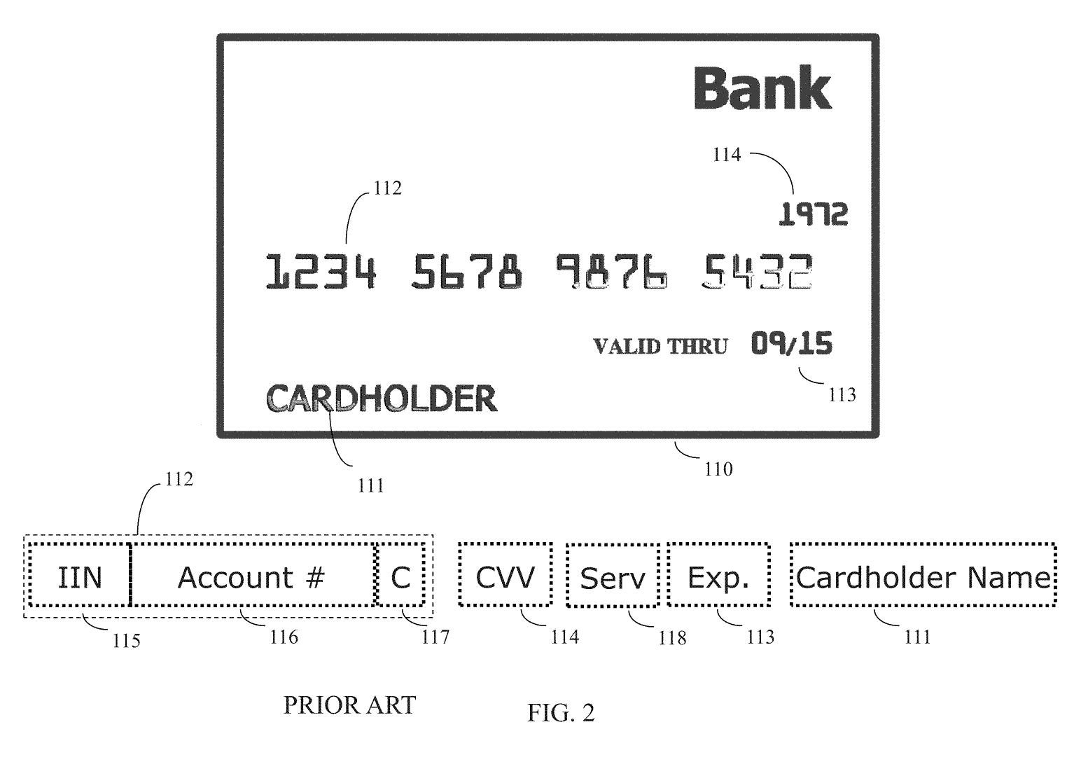

FIG. 3 illustrates one arrangement for account identifier and transaction one-time-password disposition inside standard payment fields;

FIG. 4 illustrates payment clients' initiation and registration procedure, according to certain embodiments;

FIG. 5 is a high level system architecture diagram of a first embodiment of a payment authentication system using tokenization according to certain embodiments of the invention;

FIG. 6 is a high level system and flow diagram that illustrates aspects of the payment transaction data-flow;

FIG. 7A is a high level flow diagram of a payment transaction authentication method based on a one-time-password technique;

FIG. 7B shows an example generation of a one-time password token used in transaction credentials;

FIG. 8 illustrates one arrangement of payment data fields utilization for recurring payment transactions;

FIG. 9 illustrates a flow chart of the transaction authorization process, according to certain embodiments;

FIG. 10 illustrates a flow chart of payment credentials generation procedure, according to certain embodiments;

FIG. 11 is an example Payment Authorization System transactions flow diagram;

FIG. 12 is a high level block diagram of an example payment client; and

FIG. 13 shows an example of a Card-Not-Present POS and Payment Client interaction using the POS Interface in the Payment client; and

FIG. 14 is a high level block diagram of an example Payment Authorization Server.

### DETAILED DESCRIPTION

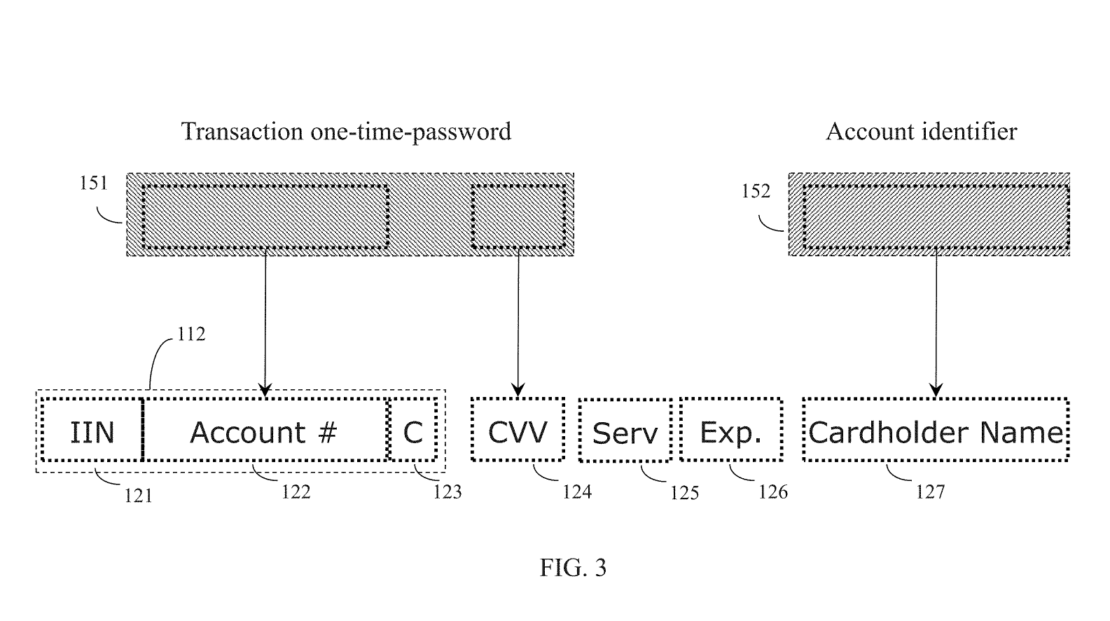

According to aspects of the present invention, and with reference to FIGS. 3-7, improved electronic transaction security and global payment capability is provided in which tokenized card data is generated at a payment client 131 without requiring access to a remote server, and where the tokenized card data can be transparently processed by a card payment system 107′.

The system makes use of a payment client 131, which can be a computerized device such as a personal computer, mobile device or tablet, a hardware token, or other computing device, and a payment authorization server 136, which can be a computing system configured to authenticate payment credentials issued by a payment client and may also authorize payment transactions. The payment authorization server may be integrated into other payment systems to support other payment related procedures.

The payment client 131 is initially registered with a Payment Authorization Server 136. The registration process links a client account identifier, such as an e-mail address or other unique identifier, to a corresponding record at the Payment Authorization Server 136. The account identifier can optionally be linked to other data as well, such as the user's transaction card information or one or more charging accounts at a Payment Service Provider. A registration process can also include authentication of the payment means, such as via a 3D Secure-like process.

During the initial registration process, one or more cryptographic keys are generated and exchanged between and/or provided to the payment client 131 and the payment authorization server 136. This information is by the client 131 to generate tokenized payment credentials and by the Payment Authorization Server 136 to authenticate a payment credential generated at the payment client 131. Other information can also be exchanged during registration, such as information needed to comply with Know-Your-Customer requirements. While registration can be done directly between the payment client 131 and the Payment Authorization Server 136, the client could alternatively engage in a registration with a separate system which then passes the registration information to the appropriate Payment Authorization Server 136. For example, if the payment authorization server is integrated with a card issuing bank, the client may register with the issuer, for example, as part of setting up an e-wallet that can be used to draw on their bank account. As will be appreciated, in such a case the client account does not need to be linked to an actual credit or debit card account but the client can use their e-wallet as if it were a credit or debit card.

When the user wants to engage in a card-not-present transaction, such as making a purchase over the internet or POS transaction, they use the payment client 131 to generate card credentials which are provided to the merchant. The payment client generates a one-time password (OTP) 151 based on information related to the transaction and other information available to the payment client 131. The OTP is positioned into one or more payment card fields, such as the card account number field 116. The account identifier is also positioned in one or more payment card fields, such as the cardholder name. Finally, additional data can be added to a payment card field so the transaction message can be properly directed during downstream processing, such as by using a value in the IIN field which refers to the Payment Authorization Server 136.

The card information is formatted to comply with appropriate standards, such PCI format. The tokenized card data is then provided to the merchant. The card data is passed and processed by various downstream entities in the card payment system 107′ in a transparent manner, such as in the form of a Financial Transaction Message. Advantageously, it is not necessary for the payment client 131 to request a token or other information from the payment authorization server, payment processor, issuer, or other third party, in order to generate secure payment credentials.

The Payment Authorization Server 136 is connected to or operates within the card payment system 107′ so that it can receive the transaction message and process it. For example, the Payment Authorization Server could be connected directly to the credit card association network 105. The issuer 106 delegates one or more of its IIN numbers to the Payment Authorization Server 136 so the transaction message is directed to it. Although shown as a separate entity, as noted above the Payment Authorization Server 136 could be integrated within an issuer or payment service provider system or other element of the card payment system, like payment processor, etc.

When the Payment Authorization Server receives a tokenized transaction message, it uses the account identifier in the transaction message to resolve one or more appropriate cryptographic keys and then uses the key(s) and other data to authenticate the one time password in the tokenized transaction message. If valid, the transaction can be authorized (communicating with third parties as appropriate) and the authorization message returned to the merchant. Otherwise, a transaction denial message can be returned.

FIG. 3 illustrates an example in a particular embodiment of account identifier and transaction one-time-password disposition inside standard payment fields of a conventional payment card. For each credit/debit card transaction, the payment client 131 may issue payment credentials in form of valid credit/debit card number and cardholder name pair. In this embodiment, the unique account identifier 152 is placed into the cardholder name field 127 and the transaction one-time-password 151 is embedded into account number 122 and CVV 124 field. The IIN field 121 is used to store an ‘issuer identification number’ that is associated with the payment authorization server 136. The payment client 131 also computes a valid checksum number 123 and provides a valid value for the expiration date 126 field. In one embodiment, the expiration date is the date of the transactions. For recurring transactions, discussed below, a different date can be specified, such as the last date the recurring transaction is valid

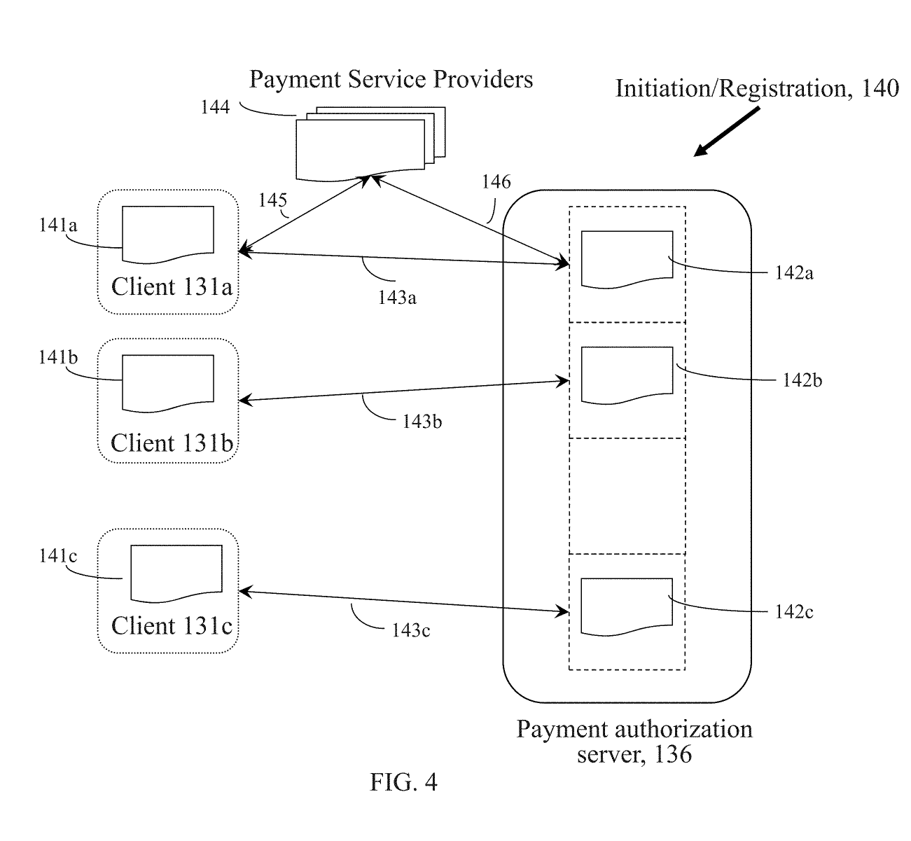

FIG. 4 is an illustration of an exemplary initiation and registration procedure of one or more clients 131a, 131b, and 131c with a Payment Authorization Server 136 and, optionally, with charging accounts at a Payment Service Provider system 144.

During registration of clients 131a, 131b, and 131c, registration records 141a, 141b, 141c are defined and stored in the respective client device. Corresponding registration records 142a, 142b, 142c are defined and stored in a database accessible to the Payment authorization server 132. The registration records available to the Payment Authorization Server 136 link a user account ID to information needed to authenticate tokenized payment credentials provided by that user/client device. The account ID can be provided by or assigned to the client. In one embodiment, the account identifier can be the client's e-mail address or derived from it. In another embodiment, the registration system assigns the account ID. The client records 142 can be stored locally to the payment authorization server 136 or stored in a remote data store, such as a secure data vault accessible, e.g., over a network. Preferably, a card holder authentication process, like as 3D secure authentication, is also employed to ensure that the user is the authorized card holder.

As noted, as part of the registration process, the client and payment authorization server exchange and/or are provided with one or more cryptographic keys and a corresponding set of one or more cryptographic keys are stored by the client 131 and in the client's record 142. The key(s) can be generated by the Payment Authorization Server 136 and provided to the client, can be generated by the client and provided to the Authorization Server, can be generated by a third system, such as an issuer and/or payment service provider (when the payment authorization server 136 is not operating transparently to such entities), and provided to both the client and the Payment Authorization Server, or the keys can be generated and distributed as a combination of these. The specifics of the key generation and exchange between the client device 131 and server and 136 and the particular key(s) stored within each device is dependent on the particular one-time-password cryptographic process employed. In a simple example only a single key is used and the same key is stored in the record 141 at the client 131 and the corresponding registration record 142.

Other information, such as personal identification information, can be stored in the client device 131 and in a respective client account record 141 that corresponds to the respective client record 142 in the server. Depending on how transactions are processed after being authorized by the payment authorization server 136, the payment authorization server may also store in the record 142 for a given client some or all of the information on the user's transaction card associated with the transaction account to be charged.

The authentication clients 131a, 131b, and 131c may be configured to also register and authenticate the card or other payment means with a Payment Service Provider 144 to reduce the possibility of registration of stolen cards. This registration/authentication may involve communications 145 between a payment client 131 and one or more Payment Service Providers 144, communication 146 between Payment Authorization Server 136 and Payment Service Provider 144, and further communications 143 between Payment Client 131 and Payment Authorization Server 136 beyond what is needed for registration without including the payment service provider. Alternatively, payment authorization sever 136 can be configured to register the client 131 with the payment service provider 144 without requiring direct communication between the client 131 and the payment service provider 144.

According to certain embodiments of the present invention, some aspects of the registration/authentication may be skipped or required one or more times depending on the configuration, application and more. For example, registration may only be valid for a limited period of time, such as one month after which at least a partial registration/authentication process must be performed again.

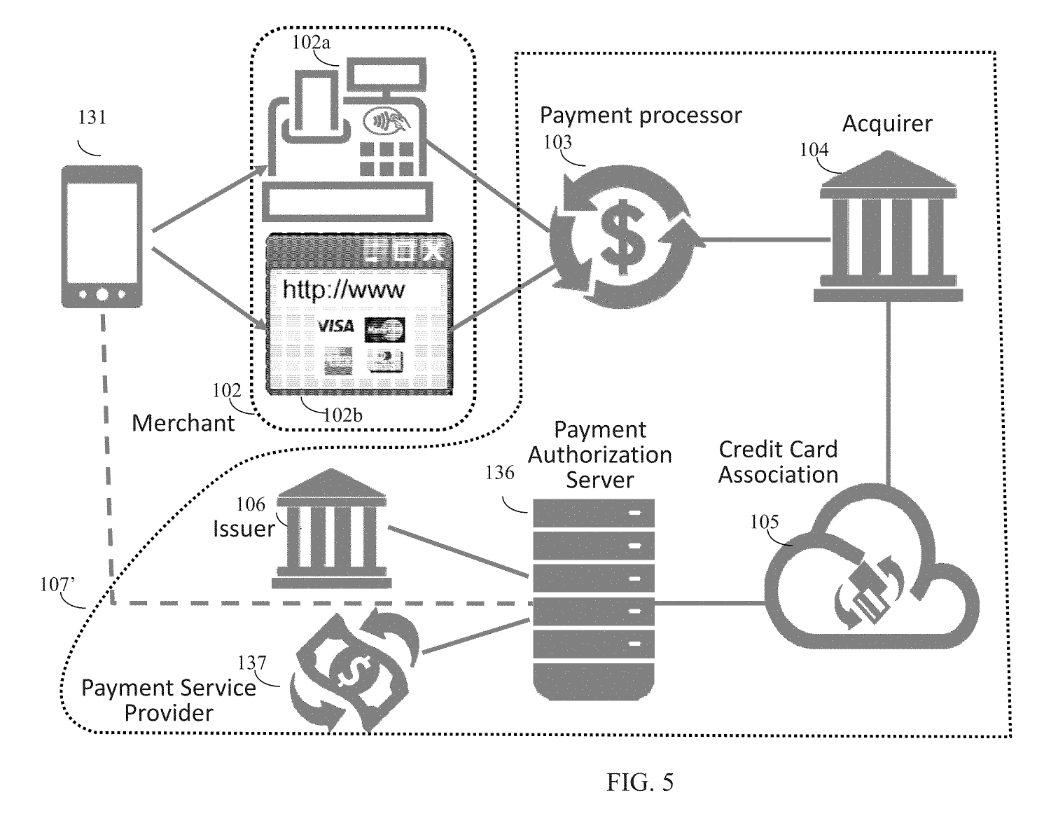

FIG. 5 is a high level system architecture diagram of a first embodiment of a payment authentication system using tokenization according to certain embodiments of the invention in which a Payment Authorization Server 136 is added to a conventional card payment system

Payment authentication system includes one or more payment clients 131 in communication with one or more merchants 102 through a suitable POS interface that provides data communication with the payment client 131. One suitable POS interface is a card-present interface 102a which communicates with a payment client 131 that is physically present at the POS 102a interface. Communication between the payment client 131 and merchant's POS interface can be via any conventional method, including a physical connection, RFID or near field communication protocols, optical communication (through a camera via 1D or 2D bar code imaging or non-imagining optical link via modulated light), voice, etc. Another suitable POS interface is a card-not-present interface 102b which allows communication with a payment client 131 over a network, such as through an internet webpage or software App running on the merchant and/or client.

The Merchant 102 is connected to card payment system 107′. System 107′ comprises a payment processor 103, an acquirer 104, and a credit card association network 105 which operate as discussed above. In this embodiment, Payment Authorization Server 136 is connected directly to credit card association network 105 and in front of the issuer processor 106, but may be connected behind or integrated within the issuer processor. It may also be connected to a payment service provider 137.

In a transaction, the payment client 131 is configured to issue secure payment credentials as discussed herein. The secure (tokenized) payment credentials are formatted so they will be accepted by merchant 102 POS systems. The payment client 131 may compute payment credentials using internally stored data. Optionally, additional data obtained from external sources (e.g. from POS, payment authorization server, issuer server, human-machine-interface, radio interface, etc.) may also be used. While the link between the payment client 131 and the merchant 102 preferably is via an automatic communication mechanism, a manual component can also be used, such as in the context of a user entering transaction details, as may be appropriate, into the payment client 131 and then providing the generated payment credentials to the merchant 102, such as through a web-page interface. For a web-page based POS interface, an internet browser can be provided with a payment software extension to support communication with the payment client device. The payment software extension may parse displayed information, extract payment information and provide it to the payment client and return payment credentials from the client to the browser for payment fields auto fill. A similar app can be provided on the client side to work with or instead of the merchant-side software extension.

Advantageously, the secured system according to the invention is transparent to the merchant and, as such, the merchant engages in a conventional transaction authorization process by sending a transaction authorization message containing the tokenized payment credentials and other transaction details (such as the transaction amount, time, etc.) to the Payment Processor 103. From there, the authorization request is passed to the relevant Acquirer 104 and the appropriate Credit Card Association network 105 using conventional processes. Although Payment Processor 103 is shown connected to Credit Card Association network 105 through an Acquirer 104, it may be directly connected to Credit Card Association network 105 instead.

When the authorization message is received by the Credit Card Association network 105, it detects information in the authorization message indicating that the authorization message should be forwarded to the Payment Authorization Server 136. Preferably, such information is in the form of an IIN number associated with the Payment Authorization Server 136 and with which the payment client 131 is registered. The Payment authorization server 134 is treated by the Credit Card Association Network 105 as if it was a conventional issuer 106. Thus, use of the present invention is transparent to Credit Card Association Network 105, the merchant 102, and the systems in between. Although one payment authorization server 136 is shown, it should be appreciated that multiple payment authorization servers 136 can be provided, each of which may have its own associated IIN number and its own set of one or more registered payment clients 131, integrated/linked issuers 106, etc.

The Payment Authorization Server 136 authenticates the secured payment credentials as discussed. A validated transaction authorization message is then generated and routed to the appropriate issuer or payment system provider for authorization. A validated transaction authorization message contains information sufficient to identify a transaction account (by a card account number, by a user identification which could be, but is not limited to, the Account ID, or other means) and other information related to the transaction and needed to determine whether to approve the transaction, such as the amount. The format of the validated transaction authorization message need not be the same as the format used by the (tokenized) transaction authorization message received by the payment authorization server 136 from the credit card association 105. The appropriate format is dependent on how the payment authorization server 136 is integrated with the issuer 106 and/or payment service provider 137. In an integrated configuration, such as where the tokenization service is offered by a bank issuer 106 to its own clients, an API interface can be used by the payment authorization server 136 to transfer the data to the issuer 106 or payment service provider 137. The API interface can be an internal system API if the payment authorization server 136 is part of the issuer server 106 or payment service provider 137. If the systems are physically separate, the API interface may be accessible through an internal or external data network. Because the issuer 106 and/or payment service provider 137 in an integrated configuration may have access to user registration information (and indeed may be responsible for the registration), the validated transaction authorization message sent over the API might only need to contain the Account ID and the transaction amount. The Issuer, etc., could then use the Account ID to look up the appropriate financial account linked to that ID to charge for the transaction and proceed accordingly.

As will be appreciated, in this configuration the user does not need to actually have a conventional card-based credit or debit account. Instead, the issuer and/or payment service provider can charge the transaction to whatever account is linked to the Account ID. This feature is particularly well suited for banks, e-wallet and similar types of applications. As will be further appreciated, in a configuration in which the payment authorization server 137 is part of the issuer 106, the IIN number of an incoming transaction message can be used by the issuer 106 to determine if an incoming transaction authorization message is tokenized or not and then route the message appropriately.

In another configuration, the payment authorization server 136 can be configured to operate transparently and independent from an issuer 106 or payment service provider 137. After an incoming tokenized transaction authorization message is validated, the payment authorization server 136 generates a transaction authorization message formatted as conventional (untokenized) transaction message, substituting for the tokenized data the untokenized payment credentials of the user, such as the primary account number (including the IIN of the issuer) and other information from the user's transaction card, retrieved based on the account ID. The validated transaction authorization message may be routed to the issuer 106 directly if this function is available to the payment authorization server 136. Alternatively, the payment authorization server 136 can send the untokenized transaction message to the Credit Card Association network 105 (in a manner analogous to Acquirer 104). The Credit Card Association network 105 will then reroute the untokenized transaction message to the appropriate issuer 106 according to the IIN number. Advantageously, from the perspective of the issuer 106, the payment authorization server is be transparent and the validated transaction authorization request from the payment authorization server 136 appears to the issuer 106 as a conventional transaction authorization request sent from the credit card association network 105. Advantageously, this embodiment allows the secure tokenized transaction method to be offered as a service to co consumers independently of their card issuer.

At the issuer 106 or payment service provider 137, the transaction authorization request is processed in a conventional manner and the request is approved or denied. The response to the authorization request is then returned to the Payment authorization server 136. In an alternative embodiment, the payment authorization server 136 may be configured to provide authorization without having to pass the request to a separate entity, such as when the payment authorization server is directly integrated within the issuer 106 or payment service provider 137.

The authorization response is then sent back to the Credit Card Association 105, to the Acquirer 104 and then payment processor 103 which then sends the approval/decline code to the merchant's POS device. (If there is no separate payment processor 103, the approval/decline code would come from the Acquirer 104).

Subsequent to the transaction approval, settlement proceeds in a conventional manner. The Payment Service Provider may initiate an off-line settlement procedure and transfer funds 232 to a Settlement Bank 220 for further transfer 233 to Acquirer Bank 104. A similar process is followed if the transaction is handled by the card issuer 106.

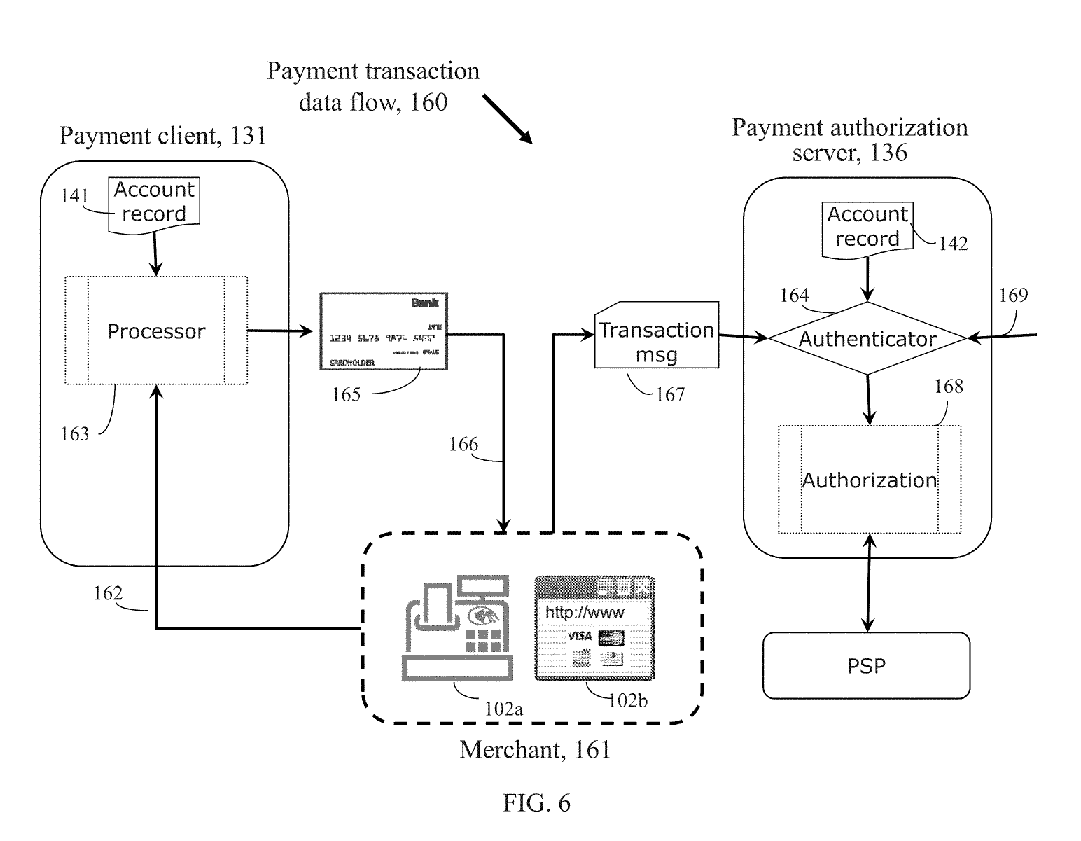

FIG. 6 is a high level system and flow diagram that illustrates aspects of the payment transaction data-flow. The processor 163 in the payment client 131 computes payment credentials 165 using transaction details obtained from the merchant POS interface 161 and data in the client account record 141, which record 141 is preferably stored in the payment client 131. The payment client 131 generates and issues transaction payment credentials 165 using its processor 163 and provides it to the merchant 161 through the POS interface 162. The Merchant system embeds the credentials into payment transaction message 167 that is passed through the card payment system to the Payment Authorization Server 136. An authenticator process 164 processes the transaction message 167 to retrieve the appropriate account record 142. Information in the Account Record 142 and in the transaction message 167 is used to authenticate the payment credentials. Depending on implementation, other data 169 may also be used by authenticator 164, such as a global time. If the received transaction message 167 is not valid, a denial response message can be generated and returned.

If the message is deemed authentic, an authorization module 168 authorizes the transaction. Authorization will generally require communication with an external system, such as an issuer or payment service provider. Alternatively, authorization for the transaction may be done entirely within the payment authorization server 136 depending on implementation.

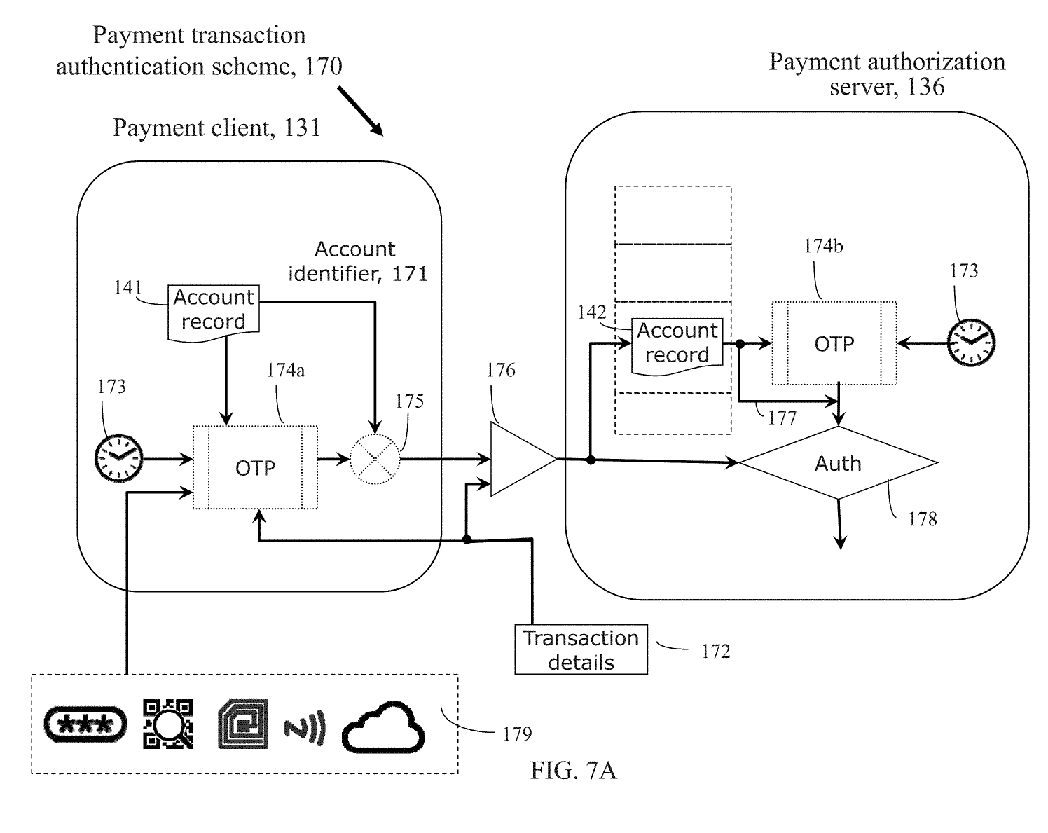

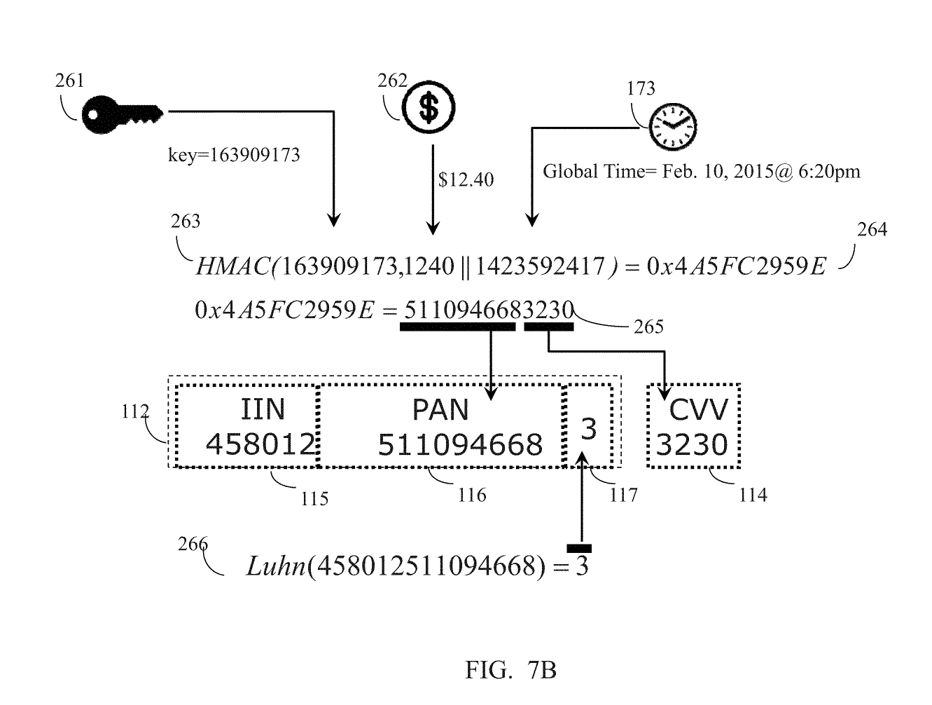

FIG. 7A is a high level flow diagram of a payment transaction authentication method based on a one-time-password technique, according to a particular embodiment of the invention. The payment client 131 generates payment credentials having Primary Account Number (PAN) 112 which comprises a static part (e.g. IIN 121 associated with the payment authorization server 136) and a dynamically generated part that is computed for the particular transaction and which is placed in the account number #122 and CVV field 124 of a conventional card number format and supplemented with checksum digit 123.

A one-time password (OTP) generating module 174a in the payment client 131 calculates the OTP using seed data comprised of information from the client's account record 141, such as one or more cryptographic keys, and payment transaction information 172, such as a transaction ID or business identifier, and the amount of the transaction. Additional information can also be used by the OTP generating module 174 as a part of the seed, such as a global time 173 (which can be obtained through a mobile network, GPS unit or a local or remote clock or provided by the merchant). Further elements 179 can also be used to provide additional seed security. For example, multi-factor authentication protection functionality can be provided by embedding into the OTP seed data additional cryptographic key or seed data obtained from source outside of payment client and entered manually or through an automatic interface. This additional data can be static, such as a fixed PIN, or dynamic and changing on a periodic or per-transaction basis. Such sources may be provided by man-machine interface (e.g. PIN code), a dynamic code from a key fob, radio interface (e.g. RFID tag, NFC label), camera (e.g. QR code, barcode), network interface (e.g. cloud stored data), etc. The use of multifactor security can be optional and specified in the client account record 141 at the payment client 131 (and in the corresponding client record 142 accessible to the payment authorization server 136).

The payment client 131 can access these additional key data automatically, such as by retrieving it from another hardware or software component within the payment client 131 or the user can be requested to provide the additional key data such as by scanning a bar code or RFID chip or entering a key number displayed on a security key fob or kept in human memory. Alternatively, or in addition, such additional key data can be obtained by requesting it from an external system, which may be the payment authorization server 136 or another system. Corresponding secure data elements are made available at the payment authorization server for subsequent use during authentication. Conventional techniques can be used to provide this corresponding data at the payment authorization server 136.

After the OPT module 174a computes the OTP, a payment credential generator 175 combines the OTP with the account identifier 171, the IIN data 121, a generated checksum and others to form the payment credentials 175.

Block 176 is an abstract representation of the merchant and other elements between the payment client 131 and the payment authorization server 136 showing the combination of the payment credentials 175 with other transaction details 172 into a transaction message.

At the payment authorization server 136, a message including the payment credentials and other transaction details is received. The received account identifier is used to access a corresponding account record 142. Information from the account record 142, such as one or more cryptographic keys and, optionally other secure data elements, is retrieved. This data, along with relevant transaction details, such as a global time 173 and/or time stamp in the transaction message is used to verify that that the received OTP is valid. The OTP module 174b can generate a validation OTP using the same or a complementary process to that used by OTP module 174a in the client device. Authentication module 178 compares the OTP generated by OTP module 174b with the received OTP in the payment credentials (generated by OPT module 174a) to authenticate the transaction. If the authentication module 178 determines that the OTPs do not match, the transaction request is rejected. Otherwise, the transaction is deemed authentic and the authenticator module 178 signals that a further authorization of the transaction (e.g., by an issuer or payment processor) can proceed.

The OTP process used in the payment client device 131 OTP module 174a and in the Payment Authorization server 136 OTP module 174b is preferably the same. As can be appreciated, the OTPs generated by these modules will only match if the seed data each uses, which is based on the client account cryptographic key(s), other client account record data, and details specific to the transaction at issue, are the same. As a result, the payment credentials are valid only for the specific transaction at issue and cannot be used for other transactions.

FIG. 7B shows an example of credential generation flow using one OTP type of OTP generation function. An initial Key 261 stored on the client is combined with dynamic seed data comprising a specific purchase amount 262 and global time 173. The combined seed data is processed using an HMAC based one-time password algorithm. The HMAC algorithm produces a hexadecimal number that can be converted into a 13 digit decimal number. The first nine decimal digits are used the account number in PAN 116, and last four digits are used as the CVV 114. The check digit 117 is calculated using Luhn algorithm 266.

As will be appreciated, if time-dependent data, such as a global time, is used by the client to generate the OTP, the payment authorization server will need to have the same data to validate the OTP. In a preferred embodiment, an assumption is made that tokenized credentials will be used by the merchant or arrive at the payment authorization server within a maximum period of time after generation, such as 10 minutes. Upon receiving a tokenized transaction message, the payment authorization server retrieves a clock value. This can be a value from an internal or external clock or a time stamp embedded by the merchant into the transaction authorization message. The payment authorization server then tries to validate the OTP using a sequence of clock values in a window surrounding the retrieved clock value. This process accounts for a temporal difference between generation of the tokenized credentials by the client and the time stamp in the transaction message or clock value accessed by the payment authorization server (depending on where the clock value is received from). It also allows for variations in clock values when the time values used are retrieved from different clocks.

For example, a client may generate tokenized credentials at 1:03 universal time. The tokenized transaction authorization message with those credentials is received by the payment authorization which retrieves its own clock time value (or retrieves the timestamp placed in the transaction authorization message by the merchant) of 1:07 UT. The payment authorization server can then sequentially try to validate the OTP using times valued 1:02 through 1:12 UT. The number of discrete time values that need to be checked is dependent on the granularity of the time value used in generating the OTP and the maximum period of time difference to accept. For example, the time value used by the OTP generation can be rounded to the nearest minute value and the window checked in OTP validation span +/−5 minutes. Longer or shorter windows can be used and the window does not need to be symmetric around the time value retrieved by the payment authorization server.

In a further variation, the client can record the time at which the OTP was generated and store this value within the tokenized credentials if space is available. For example, the time stamp can be included in an address or other supplemental field (assuming that this field is included in the transaction authorization message generated by the merchant. The time stamp data can be encrypted using a cryptographic key available to both the client and the payment authorization server, and this key could be different from the one used to generate the OTP. The embedded encrypted timestamp would then be decrypted by the payment authorization server prior to validation of the OTP.

According to a further embodiment of the invention, a system for providing secure recurring transactions is provided. The system operates in a manner similar to the system above further having one or more bits or digits in the payment credentials used as a flag to signal that the payment credentials are valid for a recurring transaction. Other information can also be provided to limit the recurring transaction. Approval of recurring transactions can also be per transaction and/or per business, statically or dynamically, explicitly or conditionally, or other manner of restrictions. The generated payment credentials can be stored by the merchant and used multiple times, such as to process a fixed monthly subscription fee.

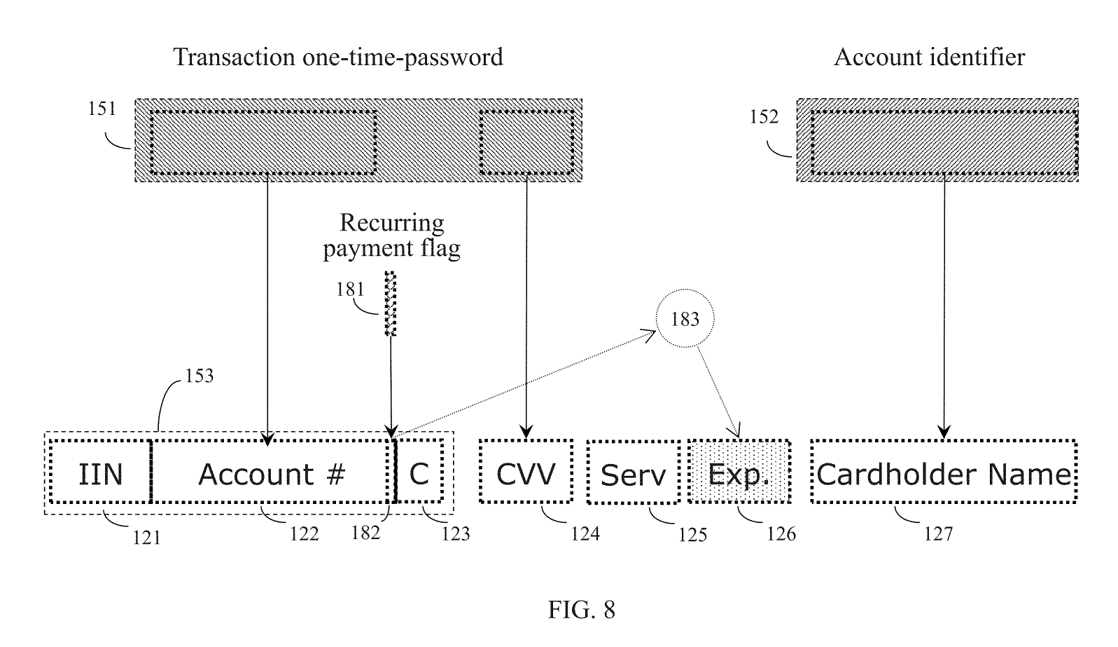

FIG. 8 shows the card data fields in a particular implementation in which the OTP 151 is placed into the account number 122 and CVV 124 card fields and with a recurring payment flag field 181 located at reserved data place 182. In addition to setting recurring payment flag 181, the payment client may also specify additional information about the recurring transaction. For example, the card expiration field 126 can be used to store expiration data 183 which indicates the period during which the transaction using the provided payment credentials can recur. Example limits include a specified date after which the payment credentials are no longer valid, a number of allowed recurring transactions, a minimum time between recurring transactions (such as at least 29 days), or a combination of one or more of these or other conditions. Where more than one type of limit is supported, the recurring payment flag can use different values to specify the type(s) of limitation placed on the recurring transaction. Other limits may be specified in the user profile data available to the payment authorization server.

When the recurring payment flag 181 is on, the generated OTP needs to be able to be recreated by the OTP module 174b in the payment authorization server 136 at times different from when the initial transaction was generated. Thus a cryptographic scheme which uses seed data that is not date/time dependent is applied. The difference can simply be the use of seed data which does not include a time/date input. However, other differences are also possible, such as the use of different keys and/or different cryptographic functions for non-recurring vs. recurring transaction OTP generation. Alternatively, the first transaction can use a timestamp based OTP generation. The timestamp from the first transaction can be stored, e.g., in the appropriate client record 142. This timestamp can then be used each time that a new authorization is required, instead of a current time, for the duration of the recurring payments.

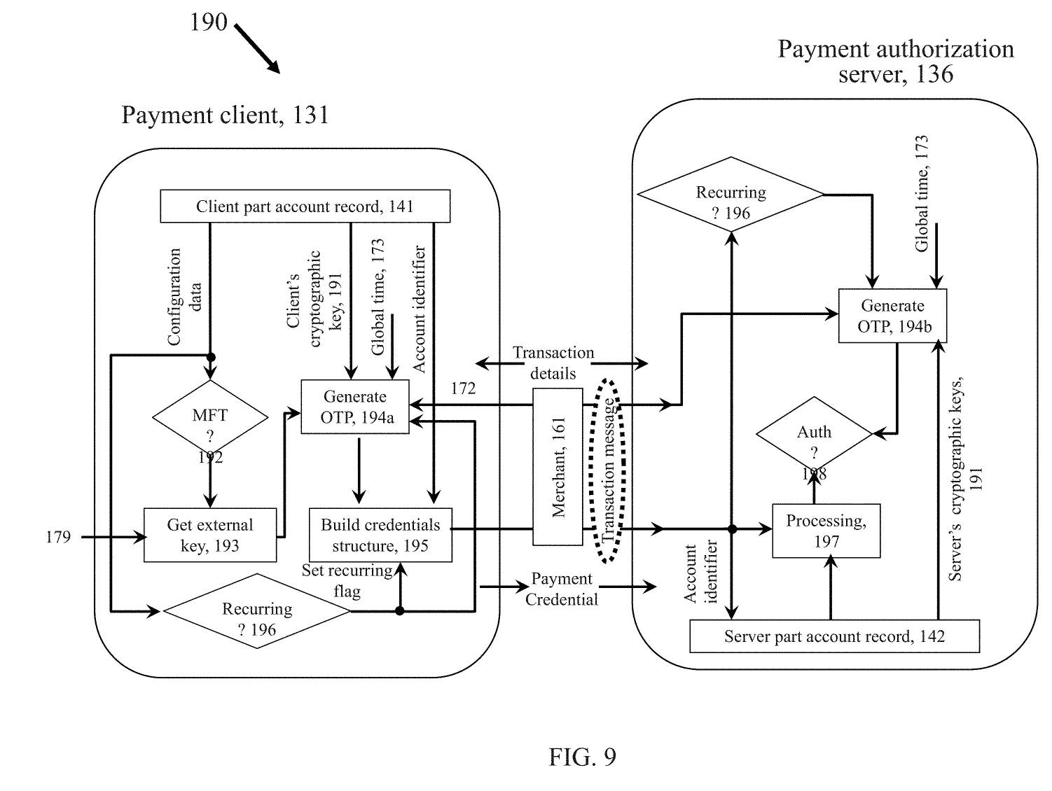

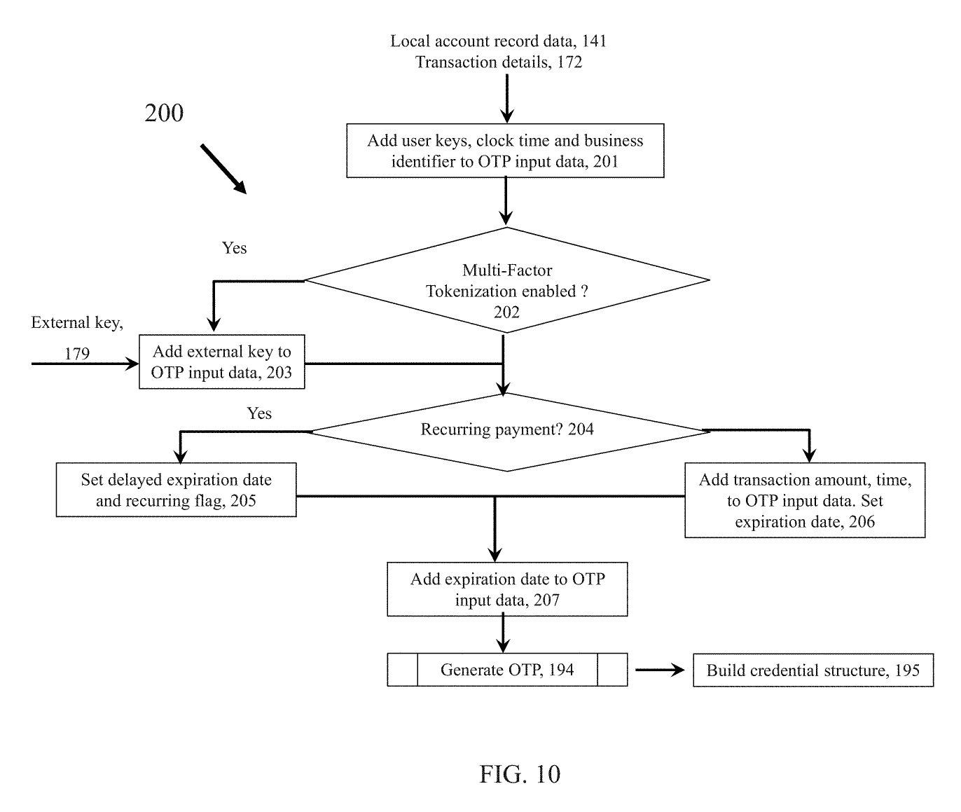

FIGS. 9 and 10 show a system and flow diagram illustrating particular implementation of a payment authorization processing that includes recurring transaction support. The Payment Client 131 receives as input the transaction details 172. The client cryptographic key(s) 191 are retrieved from the client account record 141a and input to the OTP module 194A. If the client configuration record 141a indicates that multifactor transaction security has been enabled 192, such as by setting a multifactor transaction security flag, the system retrieves additional data from other secure elements 179, such as discussed above and retrieves an external key(s) 193. This external key 193 is provided as input to the OTP module 194A.

For a non-recurring transaction, the OPT module 194A uses the client's record cryptographic key 191 along with global time 173 and transaction information 172 obtained from merchant's POS 161. If multifactor security is enabled, external key data 193 can also retrieved. The system uses this information to generate the transaction's one-time-password 194. If the transaction is designated to be recurring, this may signal the OTP module 194A to exclude global time as part of the seed data and/or to use a alternative cryptographic function from the one used for non-recurring transactions. The generated OTP is then used to build the payment credentials as discussed above, with the recurring flag set appropriately and, if set, with details specifying limits on the transaction recurrence embedded in the payment credentials as well, such as expiration data 183 stored within the expiration date field 126.

The generated payment credentials are provided to the merchant which stores and forwards this as part of a transaction message. When the transaction message is received by the payment authorization server 136, it is processed generally as discussed above. An additional input to OPT module 194B is the value of the recurring transaction flag. Analogous to its use on the client side, the flag can be used to signal whether or not temporal data, such as the global time, is used as part of the seed data. The flag may also indicate to the OPT Module 194B that an alternative cryptographic function specific to recurring transactions should be used. The authentication module 198 compares the server-generated OTP with the received OTP in the transaction message to determine if the message is authentic. If the recurring transaction flag is set, the authentication module 198 further determines if the recurring transaction is valid given limits on the recurrence. For example, determining whether or not the transaction is received before the expiration date, whether the number of recurrences has exceeded a specified limit, or whether sufficient time has passed since the previous instance of the recurring transaction.

For at least certain types of recurring transactions, such as where a maximum number of recurrences are permitted, the payment authorization server 136 will store information about recurring transactions in the associated client's account record 142 as needed for the authentication module 198 to determine if a recurring transaction is permitted.

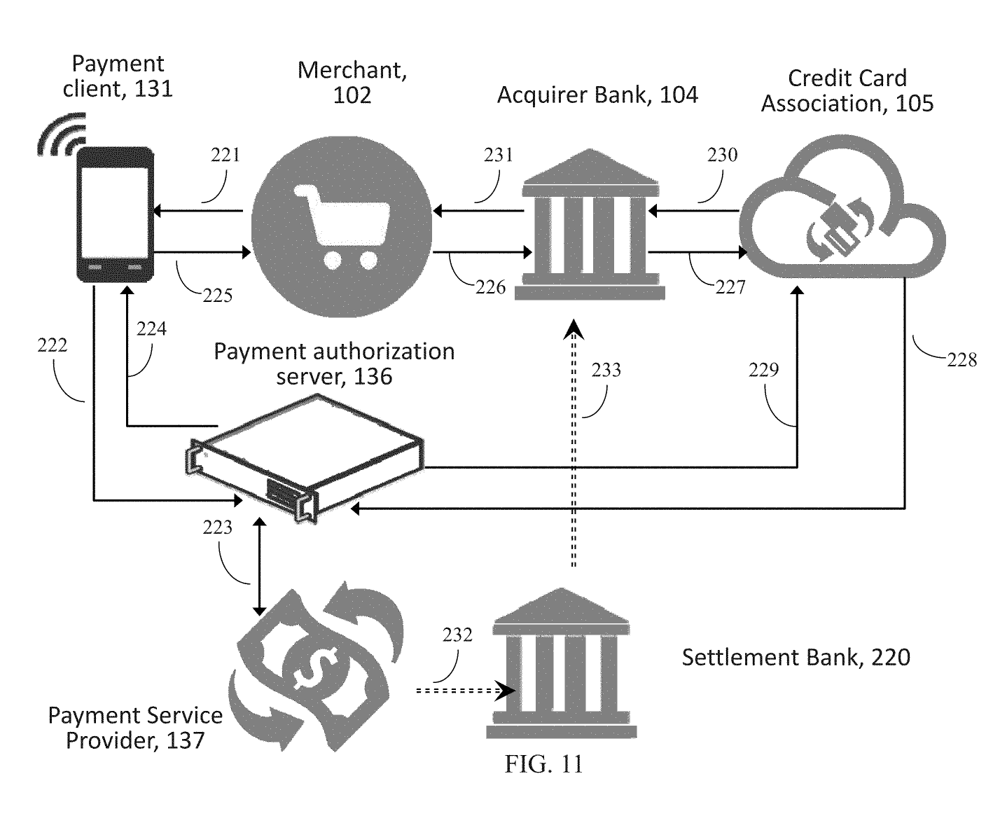

Although embodiments of the invention can be used in transactions without any direct connection between the payment client 131 and payment authorization server 136, such a connection can be used in a transaction if available in order to provide more efficient transaction processing. FIG. 11 shows an example of a Payment Authorization System transactions flow diagram in such a connection oriented environment. In a transaction, the Merchant issues a payment request 221 to the Payment Client 131 through the merchant's POS interface. The Payment Client 131 then issues a request 222 to the Payment Authorization Server 136 seeking advance approval for the transaction. The Payment Authorization Server 136 issues a request 223 to the Payment Service Provider 137 associated with the client for the transaction to be approved so that the client can be given permission to proceed. Payment service provider 137 may also capture the amount of the transaction. The Payment Service Provider 137 determines whether or not the transaction can proceed (for example by confirming that the transaction would not exceed the client's credit limit or debit an amount greater than in their account), and then indicates whether or not the transaction is approved to the payment authorization server 136 which then sends a transaction permission response 224 to the Payment Client 131.

If the payment client 131 receives permission for the transaction, it then generates the payment credentials 225 and transmits them to Merchant's POS interface 102. The merchant 102 issues an authorization request 226 to the Acquirer 104 where it is then processed as discussed above.

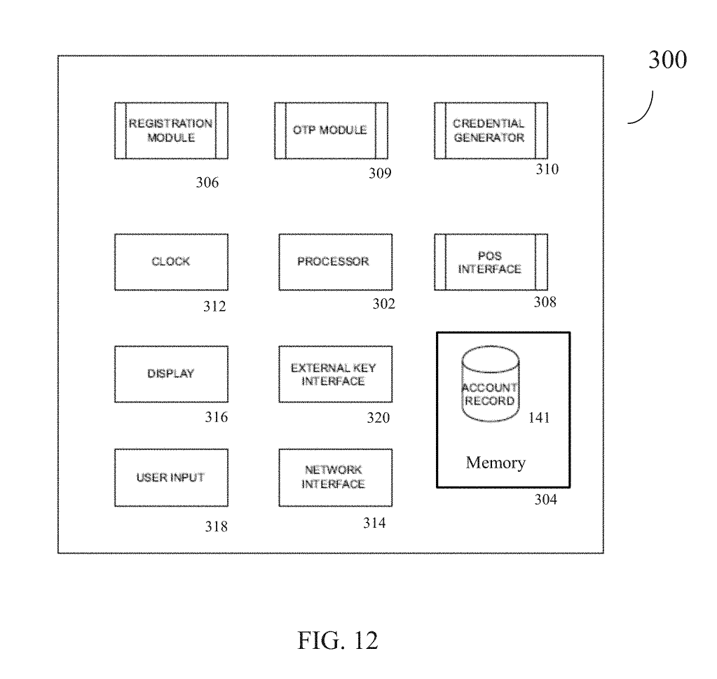

FIG. 12 is a high level block diagram of a particular payment client 300 that can operate as the payment client 131. As noted, payment client 300 can be a personal computerized device such as a personal computer, mobile device or tablet, a token, or other computing device. Payment client 300 includes a processor 302 and memory 304 that stores software as well as the client' account record 141. If the Payment client 300 is used in connection with more than one payment card, multiple client account records 141 can be stored. A registration module 306 can be provided through which the user can register a payment card with the Payment authentication server 136 and receive an account identifier and key(s) which are stored in the account record 141. A POS interface 308 can be provided to facilitate the exchange of data with the POS equipment 102a, 102b of a merchant. The POS interface 308 can be an App that works in conjunction with an internet-based e-commerce web page for the merchant. Other forms of communication between the payment client 300 and the merchant can also be provided, such as a direct physical connection (e.g., by plugging the payment client into a POS device), RFID or near field communication systems, optical communication (through a camera via 1D or 2D bar code imaging or non-imagining optical link via modulated light), voice, etc.

An OTP Module 309 and Credential Generator 310 are provided to generate the OTP and appropriately formatted payment credentials, accordingly, as discussed above. For OTP generation that includes as input a global time, this information can be obtained using an internal clock a GPS unit 312. Alternatively, this information can be obtained by querying an external system or be included in transaction data provided by the merchant. A network interface 314 can be provided to allow the payment client 300 to interact with external devices over a wired or wireless network interface. The payment client can also include a display 316 and user input 318 to provide for interactivity with a user. If no appropriate interface with the merchant POS system is available, transaction information such as the price can be manually entered by a user into the system using a keyboard user input 318. Likewise, the generated tokenized transaction credentials can be output on the display 316 so that the user can then provide that information to the merchant, such as by typing it into a website. If the OTP generation supports the use of external keys, depending on the type of key data and other input mechanisms available at the payment client 300, a separate external key interface 320 may be needed through which external key data can be provided to the payment client 131.

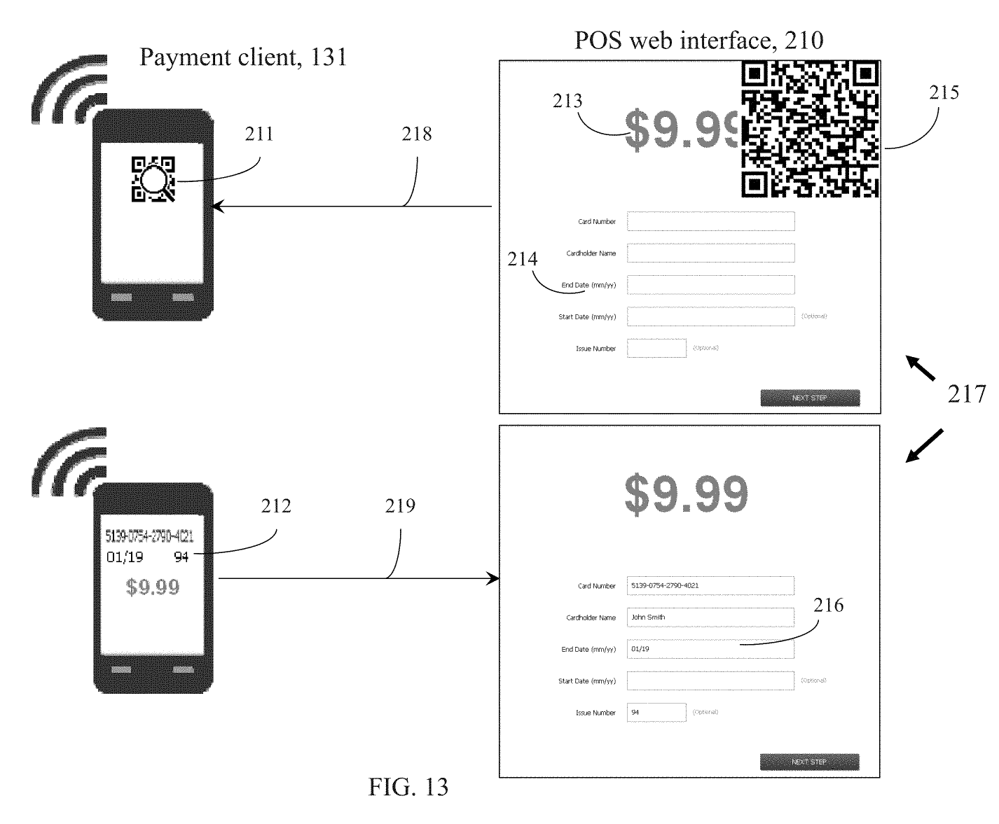

FIG. 13 illustrates one example of a Card-Not-Present POS and Payment Client interaction using the POS Interface in the Payment client 131. In a typical Card-Not-Present transaction, the user interacts with the merchant using the merchant's POS internet interface 210. Interface 210 may be equipped with a software component 217, intended to provide interaction between Payment Client 131 and POS Web Interface 210. This software may be integrated into browser using standard web browser extension mechanism (e.g. plug-in or add-on) or may be directly integrated into the browser 210 itself. The software component 217 may be able to parse information displayed on POS Web Interface 210, extract purchase information (e.g. merchant name, price 213, etc.) and provide this information to the Payment Client 131. For example, the software component 217 may provide the purchase details and additional information (e.g. merchant name, browser IP address, software component connectivity details, etc.) to Payment Client 131 by displaying it in browser window in QR code presentation 215. The Payment Client 131 may capture 218 the QR code 215 using camera and read encoded information 211. Than the Payment Client 131 may issue payment credentials 212 and to send them to software component 217 running on POS Web Interface 210, using internet connectivity (e.g. by TCP/IP protocol). Upon receiving the payment credentials, the software component 217 may automatically to fill correspondent fields in payment form 216 for further submission.

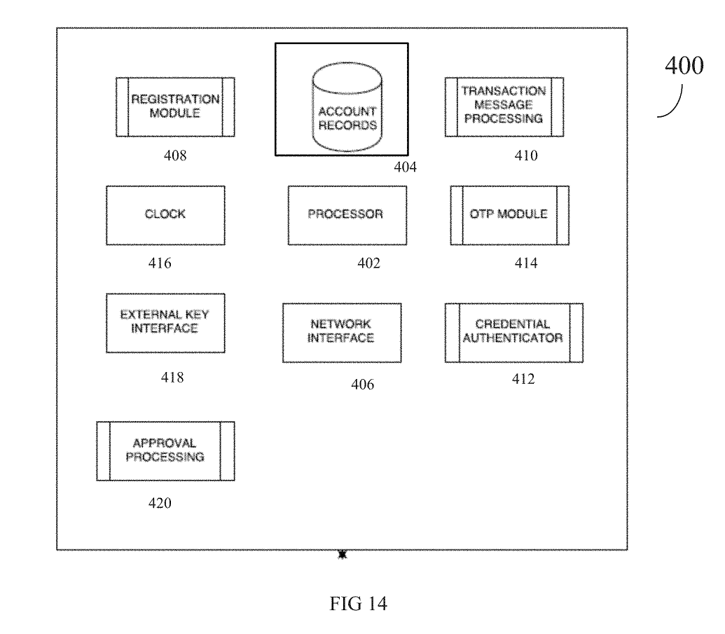

FIG. 14 is a high level block diagram of an example Payment Authorization Server 400 client 300 that can operate as the payment authorization server 131. The payment authorization server 400 is a computerized device and has a processor 402, memory 404 for storing program data including a secure database to store the various user account records 142 (if stored locally; otherwise a network link to a remote database is provided). A network interface 406 is provided and, in conjunction with appropriate software, allows for integration into the payment network and for communication with elements therein, such as the Credit Card association network 105, issuer 106 and payment service provider 136. The network interface 406 may also support communication with the payment client 131/300. A registration module 408 is provided through which a user can register a payment account with the system. The registration module 408 receives payment account data and other information from the user, generates the account identifier and relevant cryptographic keys and provides this information to the user. The registration module 408 may be accessed by the user through a secure web page of other means. A Transaction Message Processing module 410 is used to process incoming and transaction messages and output correctly formatted transaction messages for communications with other elements in the payment network.

A Credential Authenticator module 412 is provided to authenticate transaction requests and OTP Module 414 is used generate the OTP for use in authentication and with reference to data in the transaction request and relevant account records as discussed herein. For OTP generation that includes as input a global time, a clock input 416 analogous to the clock 312 of the Client 300 can be provided. Alternatively, the timestamp in the transaction authorization message could be used. If the OTP generation makes use of external key data, an External Key Interface 418 can be provided so that the Payment Authorization Server 400 can obtain that data. An Approval Processing Module 420 can be provided for sending authorized transactions to downstream issuers or payment service providers for approval. The Approval Processing Module 420 can also support client initiated pre-approvals for transactions as discussed with respect to FIG. 11.

As will be appreciated, the various aspects, embodiments, and examples of the invention as set forth herein disclose a new and specific system and algorithmic architecture and methodology that improves on existing tokenized transaction methods and systems by allowing for a secure single or recurring transaction to be entered into and processed without requiring the tokenized transaction credentials be issued to a transaction client by a third party and where the tokenized system can be implemented transparently to the merchant and others in the transaction network and used under circumstances that conventional tokenized transaction systems do not support. Various aspects, embodiments, and examples of the invention have been disclosed and described herein. Modifications, additions and alterations may be made by one skilled in the art without departing from the spirit and scope of the invention as defined in the appended claims.

What is claimed is:

1. A method for secured card transaction processing in a transaction system utilizing transaction credentials having a predefined format including an Account Number Field, a Name field, and an Issuer Identification Number (IIN) field, value of the IIN field designating a particular computer within the transaction network to which transaction messages including transaction credentials should be routed; the method implemented in a computerized client device and comprising the steps of:
receiving (i) a predefined account ID associated with a transaction account having an account number, (ii) a predefined cryptographic key associated with the account ID, and (iii) a predefined IIN number;
receiving transaction information through an input interface of the client device, the transaction information including a transaction price for a transaction;
applying a client encryption function to seed data comprising the predefined cryptographic key and at least some of the transaction information including the transaction price to thereby generate a transaction token without accessing a remote token provider system;
generating tokenized transaction credentials compliant with the predefined format and having the account ID stored in the Name field and at least a part of the transaction token in the Account Number Field of the transaction credentials, and the predefined IIN number in the IIN field; and
providing the tokenized transaction credentials on an output interface of the client device; the tokenized transaction credentials suitable for use in the transaction.

2. The method of claim 1, wherein the input interface comprises one of an optical image capture device, an RFID communication interface, and a NFC interface.

3. The method of claim 1, wherein the output interface comprises a visual display of the client device.

4. The method of claim 1, wherein the input interface and the output interface comprise an internet connection with a website of a merchant computer.

5. The method of claim 1 wherein the transaction account is one of a debit card and credit card account, the transaction account having account card credentials including an account IIN value identifying an issuer of the card account, the predefined IIN number being different from the account IIN number.

6. The method of claim 5, wherein the predefined format further comprises a Verification Code Field;
the step of generating tokenized transaction credentials comprising storing a first part of the transaction token in the Account Number Field and a second part of the transaction token in the Verification Code Field.

7. The method of claim 1, further comprising the step of obtaining a time-based value from one of a local clock and a remote clock; and wherein the seed data further comprises the time-based value.

8. The method of claim 1, further comprising the steps of:
receiving a recurring transaction designation; and
in response to an affirmative recurring transaction designation, setting a recurring transaction flag in the tokenized transaction credentials.

9. The method of claim 8, further comprising the steps of:
receiving a limitation on the recurring transaction;
the step of generating tokenized transaction credentials comprising including within the transaction credentials information representing the limitation.

10. The method of claim 8, further comprising
in response to an affirmative recurring transaction designation, selecting a first encryption function as the client encryption function, the first seed data further comprising a time-based value; and
in response to an negative recurring transaction designation, selecting a second encryption function as the validation encryption function, the first seed data not including a time-based value.

11. A payment client system for use with a transaction system utilizing transaction credentials having a predefined format including an Account Number Field, a Name field, and an Issuer Identification Number (IIN) field, value of the IIN field designating a particular computer within the transaction network to which transaction messages including transaction credentials should be routed, the system comprising:
a computing device having therein at least one computer processor, an input data interface, an output data interface, and a non-transitory computer-readable medium storing executable computer instructions, a predefined account ID associated with a transaction account having an account number, and a predefined cryptographic key associated with the account ID, the instructions when executed by the at least one computer processor, configured to cause the system to:
receive transaction information through the input interface, the transaction information including a transaction price for a transaction;
generate seed data comprising the predefined cryptographic key and at least some of the transaction information including the transaction price;
apply a client encryption function to the seed data to thereby generate a transaction token without accessing a remote token provider system;
generate tokenized transaction credentials compliant with the predefined format and having the account ID stored in the Name field and at least a part of the transaction token in the Account Number Field of the transaction credentials, and the predefined IIN number in the IIN field, the tokenized transaction credentials being suitable for use in the transaction; and
provide the tokenized transaction credentials on the output interface.

12. The system of claim 11, wherein the input interface comprises one of an optical image capture device, an RFID communication interface, a NFC interface, and an internet interface; and the output interface comprises one of the internet interface and a visual display.

13. The system of claim 11, wherein the transaction account is one of a debit card and credit card account, the transaction account having account card credentials including an account IIN value identifying an issuer of the card account, the predefined IIN number being different from the account IIN number.

14. The system of claim 11, wherein the predefined format further comprises a Verification Code Field; the instructions being configured to cause the system to store a first part of the transaction token in the Account Number Field and a second part of the transaction token in the Verification Code Field.

15. The system of claim 11, further comprising a clock interface; the instructions being configured to cause the system to obtain a time-based value from the clock interface; and generate seed data further comprising the time-based value.

16. The system of claim 11, the instructions being further configured to cause the system to:
receive a recurring transaction designation;
in response to an affirmative recurring transaction designation:
(i) set a recurring transaction flag field in the generated tokenized transaction credentials; and
(ii) include within the transaction credentials information representing a limitation on the recurring transaction.

17. The system of claim 16, the instructions being further configured to cause the system to:
in response to an affirmative recurring transaction designation, select a first encryption function as the client encryption function, the first seed data further comprising a time-based value; and
otherwise, in response to a negative recurring transaction designation, select a second encryption function as the validation encryption function, the first seed data not including a time-based value.

18. A method for secured card transaction processing in a transaction system utilizing transaction credentials having a predefined format including an Account Number Field, a Name field, and an Issuer Identification Number (IIN) field, value of the IIN field designating a particular computer within the transaction network to which transaction messages including transaction credentials should be routed; the method comprising the steps of:
in a computerized client device:
receiving (i) a predefined account ID associated with a transaction account having an account number, (ii) a predefined cryptographic key associated with the account ID, and (iii) a predefined IIN number;
receiving transaction information through an input interface of the client device, the transaction information including a transaction price for a transaction;
applying a client encryption function to client seed data comprising the predefined cryptographic key and at least some of the transaction information including the transaction price to thereby generate a transaction token without accessing a remote token provider system;
generating tokenized transaction credentials compliant with the predefined format and having the account ID stored in the Name field and at least a part of the transaction token in the Account Number Field of the transaction credentials, and the predefined IIN number in the IIN field; and
providing the tokenized transaction credentials on an output interface of the client device; the tokenized transaction credentials suitable for use in a transaction;
in a computerized transaction authorization system connected to the transaction network and having the predetermined IIN number as a unique identifier within the transaction network:
receiving the predefined account ID and the predefined cryptographic key;
receiving from the transaction system a transaction authorization message associated with a particular transaction and including transaction data and the tokenized transaction credentials;
extracting a transaction token from at least the Account Number Field of the tokenized transaction credentials;
extracting the account ID from the tokenized transaction credentials;
extracting transaction information for the specific transaction, including extracting the transaction price;
retrieving from an account database the predefined cryptographic key;
generating a first validation token using a validation encryption function operating on validation seed data comprising the predefined cryptographic key and at least some of the transaction information including the transaction price;
validating the transaction by comparing the transaction token and the first validation token, a successful validation confirming that the client encryption function functionally corresponds to the validation encryption function and that the client seed data equals the validation seed data; and
in response to a successful validation (i) generating a validated transaction authorization message including at least some of the transaction information and including and information sufficient to identify a transaction account associated with the account ID; and (ii) outputting the validated transaction authorization message.
